(19) United States
(12) Patent Application Publication
(10) Pub. No.: US 2008/0243904 A1
(43) Pub. Date: Oct. 2, 2008

(54) Methods and apparatus for storing XML data in relations

(75) Inventor: Wenfei Fan, Wayne, PA (US)

Correspondence Address: NIXON & VANDERHYE, PC, 901 NORTH GLEBE ROAD, 11TH FLOOR, ARLINGTON, VA, 22203, US

(73) Assignees: The University Court of The University of Edinburgh, Edinburgh (GB); ITI Scotland Limited of Strathclyde, Strathclyde (GB)

(21) Appl. No.: 11/729,969

(22) Filed: Mar. 30, 2007

(51) Int. Cl. G06F 17/00

(52) U.S. Cl. 707/102; 707/E17.005

(57) ABSTRACT

A method and data-processing apparatus for storing data from an XML document in a relational database, wherein the XML document conforms to an XML schema which specifies the types of elements which may be included in the XML document and child element types of the said element types, and wherein the relational database conforms to a relational schema, the method comprising the steps of, in respect of element types in the XML schema which have child element types, determining at least one rule in relation to the said element types, wherein the at least one rule specifies how to compute the value of attributes associated with child elements of an instance of an element of that type, taking into account at least the value of either or both an attribute associated with an instance of an element of that type and PCDATA of text children of an instance of an element of that type, wherein at least some of the said rules in relation to at least some of the said element types in the XML schema specify how to calculate tuples to be inserted into the relational database taking into account the value of either or both an attribute associated with an instance of an element of that type and PCDATA of text children of an instance of an element of that type; and traversing at least a required portion of the XML tree represented by the XML document, from the top down, and, for each node in the said portion of the XML tree which has child elements in the XML tree, executing the said at least one rule in relation to the element type of the node of the XML tree and, where specified by the said at least one rule, storing the computed value of the attributes of the child elements and, where it is specified by the said at least one rule, generating a tuple to be inserted into the relational database. The method enables selected data from an XML document to be stored in a pre-existing relational database and can handle XML documents which conform to a recursive XML schema.

### FIELD OF THE INVENTION

The invention relates to the field of storing of data from an XML document in a relational database of predefined schema. In a preferred embodiment, the methods and apparatus of the invention may be used to store selected data from an XML document in a pre-existing relational database, and to handle XML documents based on recursive XML schemas.

### BACKGROUND TO THE INVENTION

A number of approaches have been proposed for shredding XML data into relations, and some of these have been used in commercial systems. Most of these approaches map XML data to a newly created database of a canonical relational schema that is designed starting from scratch, based on an XML schema, such as an XML DTD (Document Type Definition), rather than storing the data in an existing relational database. Furthermore, they store the entire XML document in the database, rather than letting users select and store part of the XML data.

While some commercial systems allow a user to define a DTD-based mapping to store part of the XML data in relations, to the best of our knowledge, their ability to handle recursive DTDs is limited or they do not support storing the data in an existing database. In practice, it is common that users want to specify what data they want from an XML document, and to increment an existing database with the selected data. Furthermore, users often want to define the mappings based on DTDs, which may be recursive as commonly found in practice.

Accordingly, the invention seeks to provide methods and data-processing apparatus for storing data from an XML document in a relational database, which can potentially be used to store only selected data from an XML document or to handle XML documents based on recursive XML schema. Some embodiments of the invention may be used to increment an existing relational database.

### SUMMARY OF THE INVENTION

Exemplary methods according to the invention facilitate the storage of data from an XML document in a relational database. The XML document conforms to an XML schema which specifies the types of elements which may be included in the XML document and child element types of the said element types, and the relational database conforms to a relational schema.

For each element type in the XML schema which has child element types, at least one rule is determined in relation to the said element types. The at least one rule specifies how to compute the value of attributes associated with child elements of an instance of an element of that type, taking into account at least the value of either or both an attribute associated with an instance of an element of that type and PCDATA of text children of an instance of an element of that type. At least some of the said rules in relation to at least some of the said element types in the XML schema specify how to calculate tuples to be inserted into the relational database, taking into account the value of either or both an attribute associated with an instance of an element of that type and PCDATA of text children of an instance of an element of that type.

At least a required portion of the XML tree represented by the XML document is traversed, from the top down, and, for each node in the said portion of the XML tree which has child elements in the XML tree, the said at least one rule in relation to the element type of the node is executed. Where specified by the said at least one rule, the computed value of the attributes of the child elements is stored. Where it is specified by the said at least one rule, a tuple to be inserted into the relational database is generated.

A benefit of the method is that is able to handle recursive XML schema, although it can typically be used to generated tuples from an XML document which conforms to a non-recursive schema.

The method may be used to insert data into a pre-existing relational database. Generated tuples may be optimised by removing duplicate tuples prior to inserting data into a relational database.

When appropriate rules are selected, the generated tuples may comprise selected date from the XML document. Typically, by the selection of appropriate rules, all of the data in the XML document might be used to generate tuples.

### DESCRIPTION OF THE DRAWINGS

An example embodiment of the present invention will now be illustrated with reference to the following Figures in which:

FIG. 1 illustrates a relational schema R₀, with keys underlined, for an exemplary database in the form of a registrar database;

FIG. 2 illustrates an XML DTD D₀, except that the definition of elements whose type is PCDATA has been omitted for clarity;

FIG. 3 is a schematic tree diagram of an XML document conforming to D₀;

FIG. 4 is a schematic diagram of data-processing apparatus for carrying out the methods of the present invention;

FIG. 5 is a mapping definition document for mapping selected data from an XML document conforming to D₀ to a relational database conforming to relational schema R₀;

FIG. 6 is a flow diagram of steps carried out by an SQL update generation module; and

FIG. 7 is a mapping definition document for mapping all of the data from an XML document conforming to D₀ to a relational database conforming to R₀.

### DETAILED DESCRIPTION OF AN EXAMPLE EMBODIMENT

Within this specification and the appended claims, “XML schema” refers to a schema for an XML document defined in an appropriate XML schema language, such as Document Type Definition language (DTD), XML Schema (W3C) or RELAX NG. The invention requires an XML document to conform to an XML schema, such as a DTD, which defines at least the type of elements allowed in the XML document, and parent-child relationships between elements. An XML schema is recursive if it includes an element type defined in terms of itself, whether directly or indirectly.

Accordingly, although the method herein disclosed can be used with XML documents which conform to an XML schema in any appropriate XML schema language, the methods of the invention will be illustrated with reference to XML documents which conform to a DTD. Without loss of generality, we formalize a DTD D to be (E, P, r), where E is a finite set of element types; r is in E and is called the root type; P defines the element types: for each A in E, and P(A) is a regular expression of the form:

α::=PCDATA|ε|B_{1, . . . ,} Bₙ|B_{1+ . . . +}Bₙ|B*

where εis the empty word, B is a type in E(referred to as a child type of A), and ‘+’‘,’ and ‘*’ denote disjunction, concatenation and the Kleene star, respectively (we use ‘+’ instead of ‘|’ to avoid confusion). We refer to A→P(A) as the production of A. A DTD is recursive if it has an element type defined (directly or indirectly) in terms of itself.

It has been shown that all DTDs can be converted to this form in linear time by introducing new element types and performing a simple post-processing step to remove the introduced element types (M. Benedikt, C. H. Chan, W. Fan, J. Freire, and R. Rastogi. “Capturing both types and constraints in data integration.” SIGMOD, 2003.) To simplify the discussion we do not consider XML attributes, which can be easily incorporated. We also assume that the element types B₁, . . . , Bₙ in B₁, . . . , Bₙ (resp. B₁+ . . . +Bₙ) are distinct, without loss of generality, since we can always distinguish repeated occurrences of the same element type by referring to their positions in the production.

An XML document tree T conforms to a DTD D, if (a) there is a unique node, the root, in T labelled with r, (b) each node in T is labelled either with a type A ε E, called an A element, or with PCDATA, called a text node; (c) each A element has a list of children of elements and text nodes such that they are ordered and their labels are in the regular language defined by P(A), and (d) each text node carries a string value (PCDATA) and is a leaf of the tree. We call T a document of D if T conforms to D.

### EXAMPLE ONE

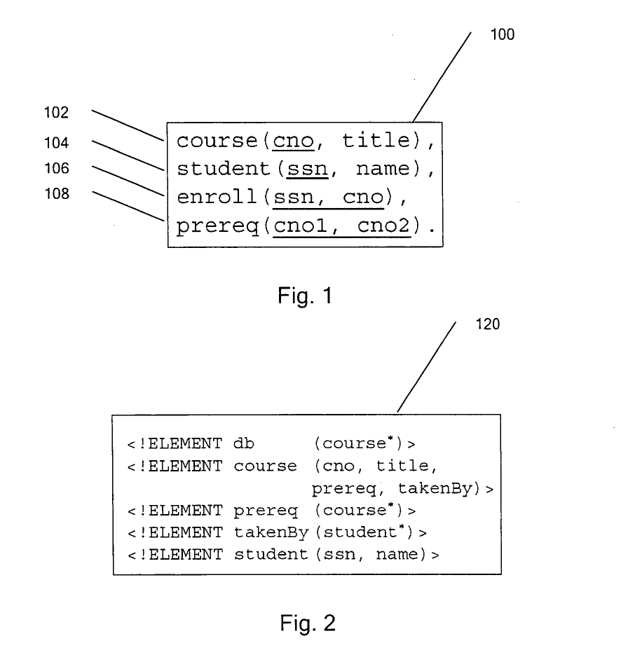

FIG. 1 illustrates a relational schema R₀ 100, with keys underlined, for an exemplary database in the form of a registrar database. The relational database maintains student data 102 (‘student’), enrollment records 104 (‘enroll’), course data 106 (‘course’), and a relation ‘prereq’ 108, which gives the prerequisite hierarchy of courses: a tuple (c1, c2) in prereq indicates that c2 is a prerequisite of c1.

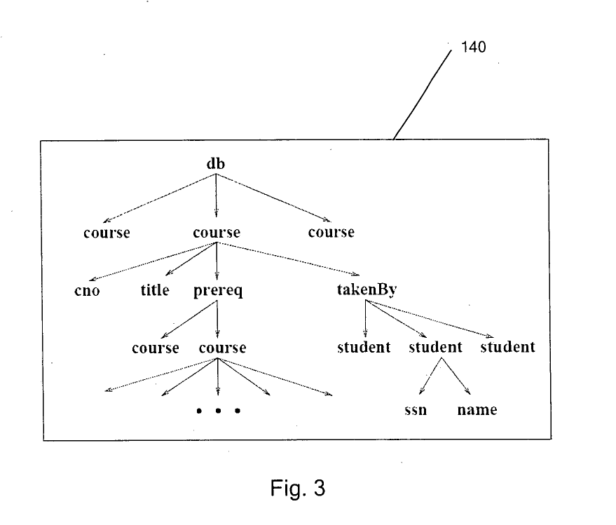

FIG. 2 illustrates an XML DTD D₀ 120 except that the definition of elements whose type is PCDATA (i.e. parsed character data) has been omitted for clarity. An XML document 140 conforming to D₀ is depicted in schematic form in FIG. 3, with arrows indicating the structure of the XML document tree T. The document has a root node (db) and includes a list of course elements. Each course element has a cno (course number) element, a course title (course) element, a prerequisite hierarchy (prereq) element, and elements concerning each of the students who have registered for the course (takenBy). Course is defined in terms of itself via prereq and so D₀ is recursive.

An exemplary application of the invention implements a mapping σ₀ that, given an XML document T that conforms to D₀ and a relational database I of R₀, extracts from T all of the Computer Science courses, (which have titles including the characters CS) along with their prerequisite hierarchies and students registered for these related courses, and inserts the data into the relations ‘course’, ‘student’, ‘enroll’and ‘prereq’ of the relational database, I, respectively.

In this example application, it is only desired to store a selected part of the data in T (data relating to Computer Science courses) in relations, rather than the entire data in T, although we will demonstrate below how the entire data in T could be stored where required.

Furthermore, in this example the selected XML data is to be stored in an existing database I with a predefined schema T, by means of SQL updates, rather than in a newly created database of a schema designed particularly for T or D₀. One skilled in the art will appreciate that the selected XML data could be stored using alternative relational query languages and that a new database with predetermined schema T could be created if it was desired to do so.

It is also notable that, in this example, because of the recursive nature of D₀, the selected XML data may reside at an arbitrary level of T, whose depth cannot be determined at compile time.

In order to prepare data for insertion into the relation database, the DTD is treated as a grammar and extended by associating semantic rules with its productions. When the XML data is parsed with respect to the grammar, semantic rules associated with the grammar are performed recursively, to select the relevant data from the XML document and generate SQL updates.

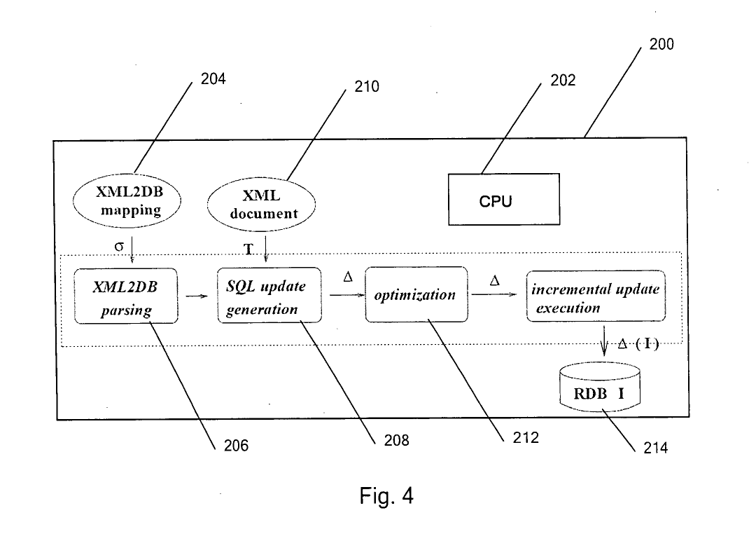

FIG. 4 illustrates data-processing apparatus 200 for carrying out the method of the present invention. The data-processing apparatus comprises a CPU 202 for performing the necessary calculations. A mapping definition document 204 specifies rules which, when executed as described below, define the mapping which is to be carried out. A parsing module 206 parses the mapping definition document. An SQL update generation module 208 reads an XML document 210 and generates a group of SQL updates. The group of SQL updates is then revised by an optimization module 212 which removes duplicates. The revised group of SQL updates is then executed on an underlying relational database 214 producing an updated relational database including the selected data from the XML document.

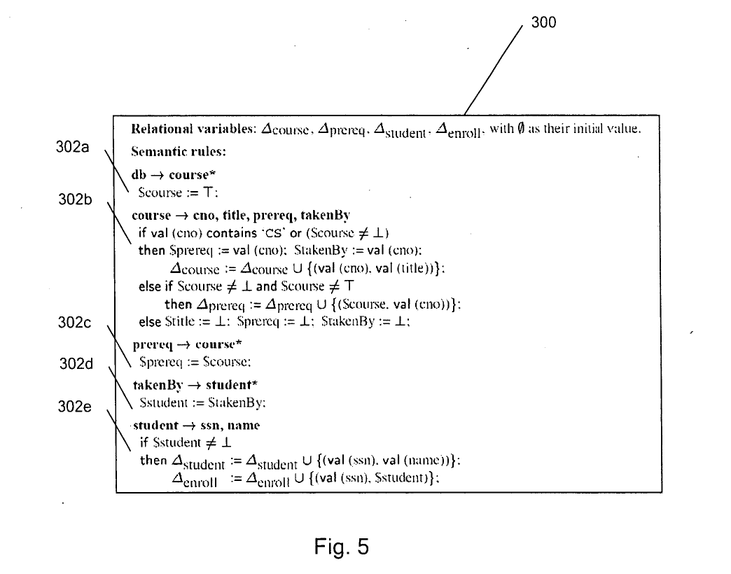

The mapping definition document is user-defined depending on the data which is to be exported to the relational database and the XML schema to which the XML document conforms. An exemplary mapping definition document 300 for implementing σ₀ is illustrated in FIG. 5.

For each production, p=A→α in D, the mapping definition document specifies a set of one or more semantic rules, rule(p). The rules 302a, 302b, 302c, 302d, 302e included in the mapping definition document specify how to calculate the value of relation variables ΔRᵢ which are defined for each relation schema Rᵢ of R. The relation variables are initially empty and are incremented during execution of the SQL update generation module to hold a set of tuples to be inserted into the relational database.

The mapping definition document also refers to semantic attributes $A for each element type A specified by the XML schema. The rules included in the mapping definition document specify how to calculate the values of the semantic attributes ($B) of B children of an A element for each child type B in α. During execution, the semantic attributes may have a value which is either a relational tuple of fixed arity and type, or a special value T or ⊥. During the evaluation procedure, the semantic attributes extract and hold relevant data from the input XML document that is to be inserted into the relational database. Because the rules specify how to calculate the semantic attributes of the children of elements, information is passed in a top-down fashion during traversal of the document tree.

The rules included in the mapping definition document specify how to increment the relation variables and how to compute the values of semantic attributes $B of child elements B of an element A using the semantic attribute $A of an element A, and the PCDATA of text children of element A. By text children, we include elements which have ‘mixed’ type or ‘any’ type and, in a particular instance, consist of PCDATA.

Each rule(p) consists of a sequence of assignment and conditional statements:
Rule (p) :=statements
Statements :=ε| statement; statement
Statement :=X=expression | if C then statements else statements
   where ε denotes the empty sequence (i.e., no semantic actions); and X is either a relation variable ΔRᵢ or a semantic attribute $B. The expressions are defined as follows:

(a) When X is $B, the corresponding expression is a tuple construction (x₁, . . . , xₖ), where X₁ is either of the form $A.a., (i.e., the a field of the tuple-valued attribute $A of the A element), or val (B′), where B′ is an element type in a such that its production is B′ PCDATA, and val (B′) denotes the extraction of the PCDATA (parsed string) data of the B′ child.

(b) When X is ΔRᵢ, the corresponding expression is a union ΔRᵢ∪{(x_{1, . . . ,} xₖ)}, where (X_{1, . . . ,} X_{k,}) is a tuple as described above and in addition, it is required to have the same arity and type as specified by the schema ΔRᵢ. The condition Cis defined in terms of equality or string containment tests on atomic terms of the form val (B′) $A.a, T, ⊥, and it is built by means of Boolean operators and, or and not, as in the standard definition of the selection conditions in relational algebra (see, for example, S. Abitebaul, R. Hull and V. Vianu, Foundations of Databases. Addison-Wesley, 1995, which is incorporated herein by virtue of this reference).

It will be seen that the rules included in the mapping definition document of FIG. 5 specify the generation of relation variables Δcourse, Δstudent, Δenroll and Δprereq, from which SQL updates can be readily constructed. Note that in the mapping definition document, the special symbol T is used in rule(course) to distinguish the invocation of the course production triggered by the root db from its invocation by prereq. Furthermore, the special value ⊥ indicates that the corresponding XML elements are not selected and thus do not need to be processed, which enables the avoidance of unnecessary processing steps.

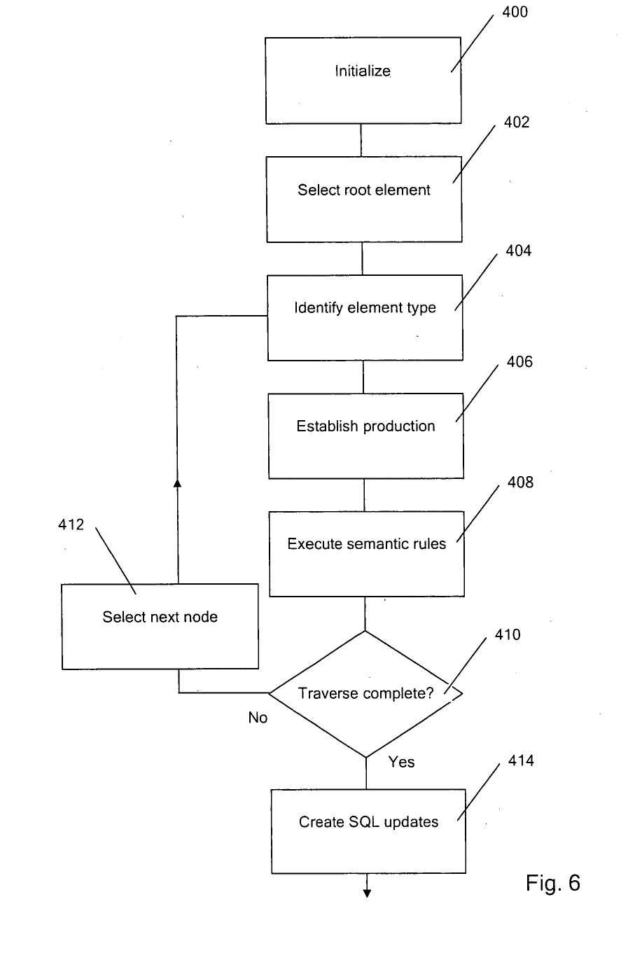

FIG. 6 is a flow diagram which illustrates the procedures carried out during the execution of the SQL update generation module. Given an input XML document T, the SQL update generation module conducts a top-down depth-first traversal of the XML tree of T The procedure begins with an initialisation step 400 in which the special value T is assigned to each semantic attribute $r of the root r of T and the relational variables, Δcourse, Δprereq, Δstudent and Δenroll are each assigned Ø (the empty set) as their initial value. The top-down depth-first traversal then begins by selecting the root element 402. As each element v is selected, its type (hereafter, A), is identified 404. The corresponding production p=A→P(A) is established 406 depending on the applicable XML schema.

The semantic rule or rules associated with the established production is then executed 408. This step may involve extracting PCDATA, val(B′) from some B′ children, projecting on certain fields of the attribute t of v, and performing equality, string containment tests and Boolean operations, as well as constructing tuples and computing union of sets as specified by the relevant rule (p). The execution of rule (p) assigns a value to the semantic attribute $B of each B child of v if the assignment of $B is defined in rule(p), and it may also extend the relation variables ΔRᵢ. In particular, if p is of the form A→B*, then each B child, u of v is assigned the same value $B.

Unless it is determined 410 that the traversal has completed, the next node in the top-down depth-first traversal is selected 412 and the relevant rules are executed as before. Thus, each child u of v is processed in turn, using the semantic attribute value of u. Once it is determined that the traversal has completed, the value of the relation variables is output and used to construct SQL updates 414. Control is then passed to the XML optimization module.

The top-down depth-first traversal proceeds systematically through each node which has children, except that where a child element u has been assigned the special value ⊥, neither that element nor any node of the branch beginning with that element are processed.

In the present example, the semantic rule 302a associated with the production of the root element db→course* is evaluated first and all of the course children of the root of T are given T as the value of their semantic attribute $course.

As a result of the given definition of the semantic rule 302b course→cno,title,prereq,takenBy, for each course element v which is encountered during the traversal, if either $course contains ‘CS’ or is not ⊥, i.e. v is either a CS course or a prerequisite of a CS course, the PCDATA of cno of v is extracted and assigned as the value of $title, $prereq and $takenBy, moreover, the relation variable Δcourse is extended by including a new tuple describing the course v. Furthermore, if $course is not T, indicating that v is a prerequisite of a CS course c rather than a child of the root, then Δprereq is incremented by adding a tuple constructed from $course and val(cno), where $course is the cno of c inherited in the top-down process. Otherwise the data in v is not to be selected and thus all the semantic attributes of its children are given the special value ⊥.

As a result of rule 302c, for each prereq element u which is encountered, the semantic attributes of all the course children of u inherit the $prereq value of u, which is in turn the cno of the course parent of u, similarly for takenBy elements (rule 304d).

For each student element s which is encountered, if $student is not ⊥, i.e., student s registered for either a CS course c or a prerequisite c of a CS course, the relation variables Δstudent and Δenroll are incremented by adding a tuple constructed from the PCDATA val (ssn), val (name) of s and the semantic attribute $student of s (rule 304e). Note that $student is the cno of the course c.

Thus, the example method creates tuples from which SQL updates can be readily created and used to increment an existing relational database with selected data from the XML document. Of course the method could equally be used to create a new relational database according to a predetermined schema where this was desirable.

Furthermore, the example method is capable of handling recursive XML schemas. Indeed, course is recursively defined in this example. Recursion in an XML schema has been achieved by following data-driven semantics. The evaluation is determined by the input XML tree T at run-time and always terminates because T is finite. No node of the XML tree has had to be visited more than once. Because the semantic attributes of children nodes inherit (by which we mean, are computed by using) the semantic attributes of their parent, information and control has been passed in a top-down fashion during the evaluation procedure.

Before incrementing the relational database, the SQL insert generated from each relation variable ΔRᵢ can be optimised by eliminating duplicate tuples in ΔR_{i.}, either before or after creating the SQL insert. This takes at most O(m log m)time, where m is the size of ΔRᵢ. Note that the order of inserting the tuples in ΔRᵢ and the order of executing inserts are irrelevant since only tuple insertions are involved.

### EXAMPLE 2

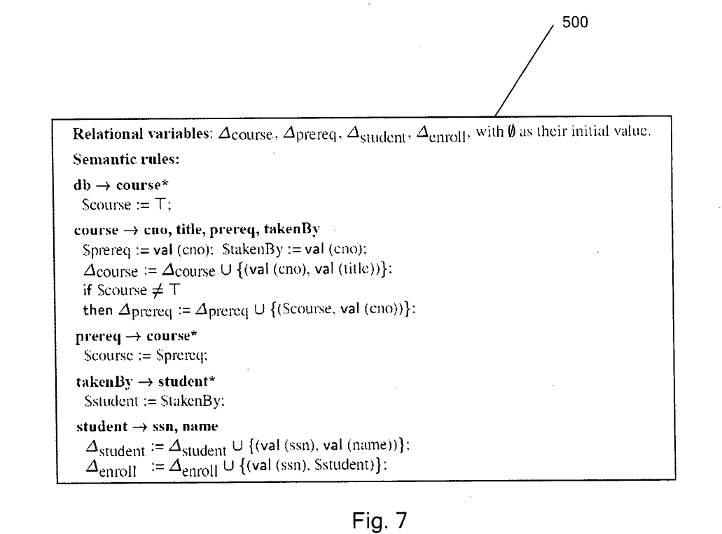

### Storing the Entire Document

Where it is desirable to do so, all of the data represented by the XML document may be shredded into a relational database. For example, the mapping definition document 500 of FIG. 7, when executed by the data-processing apparatus described above, shreds all the data represented by an XML document which corresponds to an XML schema into a relational database of predetermined relational schema.

### EXAMPLE 3

### Use of Streaming XML Interface

In a third example, we present an alternative methodology for carrying out the mappings of the present invention, based on a mild extension of streaming XML interfaces, such as SAX parsers. SAX parsers are described in D. Megginson, “SAX: A simple API for XML” (http://www.megginson.com/SAX/) and www.saxproject.org. A SAX parser reads an XML document T and generates a stream of SAX events of five types, whose semantics are self-explanatory:
startDocument( )
startElement(A, eventNo)
text(s)
endElement(A)
endDocument( ).
   Where A is an element type of T and S is a string (PCDATA).

A SAX parser (or other streaming XML interface) has the effect of traversing an XML document tree as the startElement events will be generated in an order which corresponds to a top-down traversal of the XML document tree.

Accordingly, the SQL update generation module may be implemented by event responsive modules which are executed in response to the generation of SAX events. One skilled in the art will appreciate that the event responsive modules may be integrated into or separate to the SAX parser. As with the first and second examples, relation variables ΔRᵢ are stored in respect of each relational schema Rᵢ in the relational schema R. The semantic attributes $A are stored in a stack S during execution of the SQL update generation module. Variables X of string type are used to hold the PCDATA of text children of each element which is being processed in order to construct tuples to be added to the relation variables, ΔRᵢ. The same string variables can be used when processing different elements. In contrast to the methods of examples 1 and 2, the step of computing the value of the semantic attributes of child elements can take place at a different time to the step of computing the tuple to be inserted into the relational database via the relation variables, ΔRᵢ.

In response to the event startDocument( ), an event handler pushes the special symbol T onto the stack S as the semantic attribute $R of the root r of the input XML document T.

When the event startElement(A,eventNo) is generated, the semantic attribute $A of the A element v which is being parsed is already at the top of the stack S. In response to the event startElement(A,eventNo), then, for each child u of v which has to be processed, we compute the semantic attribute $B of u using the corresponding semantic rule(p) specified by the mapping definition document for the production p=A→P(A). The value of the computer semantic attribute $B is pushed onto S. The children u will be processed in turn as the SAX parser proceeds through the XML document. If the production of the type B of u is B→PCDATA, the PCDATA of u is stored in a string variable X. It is worth mentioning that by the definition of XML2DB mappings, the last step is only needed when p is of the form A→B₁, . . . , Bₙ or A→B₁+ . . . + B_{n.}

Straightforward induction shows that when this event is encountered, the semantic value $A of the A element being processed is at the top of the stack S. In response to the event endElement(A), two steps are carried out. Firstly, the relation variables ΔRᵢ are incremented by executing the rule relating to ΔRᵢ in rule (p) using the value of the relevant semantic attribute $A and the PCDATA values stored in the string variables. $A is then popped off the stack.

In response to text(s) events, the PCDATA s is stored in a string variable, if necessary.

Finally, in response to the event endDocument ( ), the relation variables ΔRᵢ are output and the semantic attribute at the top of the stack is popped off S. The resulting tuples can then be optimized by the removal of duplicates and used to construct SQL updates which are then used to increment the relational database.

Thus, the entire XML documents can be processed in a single traversal of T, in O(|τ∥σ|) time where |τ| and |σ| are the sizes of T and σ respectively. In addition to relation variables to hold the tuples to be inserted, the space required by the passer consists of a stock bounded by the depth of T and at the most n string variable, where n is the length of the largest production in the DTD D. This compares favourably with memory-intensive procedures which use Document Object Models (DOMs).

Although the embodiments of the invention described with reference to the drawings comprise methods performed by data-processing apparatus, and also data-processing apparatus, the invention also extends to computer program instructions, particularly computer program instructions on or in a carrier, adapted for carrying out the processes of the invention or for causing a computer to perform as the data-processing apparatus of the invention. Programs may be in the form of source code, object code, a code intermediate source, such as in a partially compiled form, or in any other form suitable for use in the implementation of the processes according to the invention. The carrier may be any entity or device capable of carrying the program instructions.

For example, the carrier may comprise a storage medium, such as a ROM, for example a CD ROM or a semiconductor ROM, or a magnetic recording medium, for example a floppy disc or hard disc. Furthermore, the carrier may be a transmissible carrier such as an electrical or optical signal which may be conveyed via electrical or optical cable or by radio or other means. When a program is embodied in a signal which may be conveyed directly by cable, the carrier may be constituted by such cable or other device or means.

The embodiments described herein are by way of example only and further modifications and variations may be made within the scope of the invention.

What is claimed is:

1. A method for storing data from an XML document in a relational database, wherein the XML document conforms to an XML schema which specifies the types of elements which may be included in the XML document and child element types of the said element types, and wherein the relational database conforms to a relational schema, the method comprising the steps of:
in respect of element types in the XML schema which have child element types, determining at least one rule in relation to the said element types, wherein the at least one rule specifies how to compute the value of attributes associated with child elements of an instance of an element of that type, taking into account at least the value of either or both an attribute associated with an instance of an element of that type and PCDATA of text children of an instance of an element of that type, wherein at least some of the said rules in relation to at least some of the said element types in the XML schema specify how to calculate tuples to be inserted into the relational database taking into account the value of either or both an attribute associated with an instance of an element of that type and PCDATA of text children of an instance of an element of that type; and
traversing at least a required portion of the XML tree represented by the XML document, from the top down, and, for each node in the said portion of the XML tree which has child elements in the XML tree, executing the said at least one rule in relation to the element type of the node of the XML tree and, where specified by the said at least one rule, storing the computed value of the attributes of the child elements and, where it is specified by the said at least one rule, generating a tuple to be inserted into the relational database.

2. A method according to claim 1, wherein the relational schema is predetermined.

3. A method according to claim 2, wherein the relational database is pre-existing and at least some of the generated tuples are inserted into the relational database

4. A method according to claim 3, wherein the generated tuples are stored prior to insertion into the relational database.

5. A method according to claim 4, comprising the step of determining whether stored tuples are duplicates and only inserting duplicated tuples into the relational database once.

6. A method according to claim 5, wherein duplicate tuples are only inserted into the relational database once by deleting duplicate tuples.

7. A method according to claim 1, wherein at least some of the said rules, in relation to at least some of the said element types in the XML schema, are selected so that tuples are generated in respect of only some of the data specified by the XML document.

8. A method according to claim 7, wherein at least one of the said rules is operable to specify that a portion of the XML tree does not need to be traversed by setting the attribute associated with a child element to a special value which indicates that rules need not be executed in relation to that element and children of that element.

9. A method according to claim 1, comprising the step of setting the attribute associated with the root element of the XML tree to a special value so that the rules can specify alternative activities to be carried out in respect of an instance of an element depending on whether it is the root element type.

10. A method according to claim 1, wherein the step of traversing at least a required portion of the XML tree comprises parsing the XML document using a streaming XML interface which generates events responsive to features in the XML document in an order corresponding to the order of the features in the XML document, wherein the generated events include at least events responsive to the beginning of an XML element in the XML document and events relating to the end of XML elements in the XML document.

11. A method according to claim 10, wherein the value of attributes associated with child elements of a node are calculated responsive to the generation of an event which is responsive to the beginning of an XML element.

12. A method according to claim 11, wherein a stack is maintained and the value of attributes associated with child elements is pushed onto the stack responsive to the generation of an event which is responsive to the beginning of an XML element.

13. A method according to claim 11, wherein tuples are generated responsive to the generation of events which are responsive to the end of an XML element.

14. A method according to claim 10, wherein the step of traversing at least a required portion of the XML tree is carried out by a SAX parser.

15. A method according to claim 1, wherein each node of the XML tree which is visited during the traverse of the XML tree is visited only once.

16. A method according to claim 1, wherein the XML schema is recursive.

17. A method according to claim 1, wherein the XML schema is a DTD.

18. A method according to claim 1, wherein the rules are defined by a mapping definition document which is customised depending on the XML schema, the relational schema and the data from the XML schema which is to be used to generate tuples.

19. A method according to claim 1, wherein at least one of the said rules comprise conditional statements which depend on the value of either or both an attribute associated with an element of that type and PCDATA of text children of an instance of an element of that type.

20. Data-processing apparatus comprising a processor and program code which, when executed, is operable to carry out a method according to claim 1.

21. A relational database which has been incremented using tuples generated by a method according to claim 1.

22. A storage medium having program code instructions which, when executed on a computer, cause the computer to carry out a method according to claim 1.
